(19) United States
(12) Patent Application Publication
(10) Pub. No.: US 2007/0159574 A1
(43) Pub. Date: Jul. 12, 2007

(54) Common transparent electrode for reduced voltage displays

(75) Inventors: Mitchell S. Burberry, Webster, NY (US); Charles M. Rankin JR., Penfield, NY (US); Theodore K. Ricks, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/327,724

(22) Filed: Jan. 6, 2006

(51) Int. Cl. G02F 1/1347

(52) U.S. Cl. 349/74

(57) ABSTRACT

The present invention relates to a display comprising, in order, a support, a first patterned conductor, a first level of electrically modulated imaging material, a coextensive common electrode conductor, a second level of electrically modulated imaging material, and a second patterned conductor and a method of imaging the display.

### FIELD OF THE INVENTION

The present invention relates to a structure and drive scheme to more efficiently image bistable displays.

### BACKGROUND OF THE INVENTION

Displays comprising a transparent substrate, transparent electrodes disposed on the substrate, a polymer dispersed cholesteric liquid crystal disposed over the transparent electrodes, a contrasting absorbing layer disposed over the liquid crystal layer and printed top electrodes have been described as, for example, in U.S. Pat. No. 6,788,362 and references therein. These displays have several advantages over displays having liquid crystal layers disposed between multiple glass or plastic supports and displays having multiple stacked transparent electrodes with alternating patterns of rows and columns. These advantages include ease of manufacture, lower cost and more flexible designs.

Bistable cholesteric liquid crystal displays have advantages over more conventional liquid crystal displays in that they do not require polarizing filters and can be addressed in a passive matrix. These displays suffer from the added thickness due to the polymer host and the absorber layer disposed between the row and column electrodes. This structure leads to higher drive voltages particularly with respect to the reset voltage required to return pixels to the stable planar state. Higher drive voltages in turn lead to higher system costs.

U.S. Pat. No. 4,423,929 discloses a multilayer display device including at least two liquid crystal display cells overlapping along a line of sight. Adjacent display cell layers may share a common transparent plate therebetween. Patterns are displayed by selectively applying a voltage between opposed pattern and common electrodes. The number of signal wires removed from the device is reduced by electrically connecting electrodes in different layers. The connected electrodes may be non-overlapping to increase the number of characters, which may be displayed simultaneously, or may be overlapping for independent displays. Generally speaking, in accordance with the invention, an improved digital display device including a plurality of individual display cells overlapping along a line of sight is provided. A liquid crystal display device constructed in accordance with the invention includes at least two display cells of opposed transparent plates, the cells overlapping in plan view. Transparent pattern electrodes are provided on one interior surface of one plate of each cell and at least one transparent common electrode is disposed on the opposed transparent plate of that cell. The transparent pattern electrodes are for forming display patterns when a voltage is selectively applied between segments of the pattern electrodes and the opposed common electrodes. Adjacent display cell layers may share a common transparent plate therebetween with transparent electrodes deposited on both surfaces of the common plate. The segments of the pattern electrodes may form the seven bar alpha-numeric segmented characters or may form a complete number or letter. These displays require multiple transparent substrates leading to higher cost, thicker less flexible displays and require separate drive signals for each imaging layer.

U.S. Pat. No. 5,796,447 discloses a liquid crystal display and, more particularly, a reflection liquid crystal display. The invention provides a plurality of pixels, arrayed in a matrix format on the liquid crystal panel of a liquid crystal display. Guest-Host (GH) liquid crystal layers and transparent electrodes for displaying a plurality of different colors are alternately stacked on a reflecting plate, and therefore each pixel has three liquid crystal layers. Pieces of potential information supplied to the respective liquid crystal layers are controlled by switching elements connected to signal lines and scanning lines. The signal lines and the scanning lines are respectively connected to driving integrated circuits (ICs), which are connected to a signal processing circuit. In each pixel, while the potential information of one liquid crystal layer is controlled, the remaining liquid crystal layers are set in a floating state. This display requires a plurality of alternating transparent electrodes (i.e. patterned alternating rows and columns) between stacks of liquid crystal layers. Although this is desirable when addressing full color displays, the requirement of alternating electrodes adds to the number of independent driver signals required, the number of connections required and increases the complexity of fabrication, all leading to higher system costs. These displays also lack the interposed absorbing layer between the electrodes thus reducing the effectiveness of a contrasting absorber layer.

U.S. Pat. No. 5,764,317 discloses three dimensional volume visualization displays that have a volumetric multilayer screen. Specifically, a preferred embodiment of the invention is directed to a volumetric multilayer screen having a plurality of electrically switchable layers whose optical properties are electrically switchable. This disclosure relates to volume visualization displays of the type that can be termed a switchable multilayer display. A volumetric multilayer screen including a plurality of electrically switchable layers that are stacked and coextensive, each of the plurality of electrically switchable layers including: a first transparent dielectric substrate having a first side and a second side; a first transparent electrode coated on the first side of the first transparent substrate; and an electrically switchable polymer dispersed liquid crystal film coated on the first transparent electrode. The electrically switchable polymer dispersed liquid crystal film includes a) a host polymer having an index of refraction and b) a nematic liquid crystal having i) an ordinary index of refraction that substantially matches the index of refraction of the host polymer when an electric field is applied across the electrically switchable polymer dispersed liquid crystal film from the first transparent electrode, and ii) an extraordinary index of refraction that causes visible light to be scattered at a host polymer/nematic liquid crystal interface when the electric field is not applied across the electrically switchable polymer dispersed liquid crystal film by the first transparent electrode. These displays also suffer from having multiple supports.

U.S. Pat. No. 6,593,901 discloses an electronic device employing a multilayer display apparatus, in which multiple layers are combined such as liquid crystal display panel layers, and more specifically to electronic device so designed as to combine display states of the multilayer display panel layers. The invention is described as an electronic device provided with a multilayer display panel, in which, during information display by any display panel layer of the multilayer display panel, display driving means maintains all the display segments of the other display panel layer to be off, allowing simple display control. The electronic device disclosed does not utilize cholesteric liquid crystalline materials and requires polarizing filters.

WO0046636 discloses a multilayer or stacked cholesteric liquid crystal display and, more particularly, a stacked cholesteric liquid crystal display utilizing a single set of drive electronics to drive a plurality of spaced apart sets of row electrodes and sets of column electrodes affixed to a plurality of stacked substrates. The stacked, passive display apparatus includes first and second layers of chiral nematic liquid crystal material, which includes substrates binding the first layer of liquid crystal material and the second layer of liquid crystal material so as to prevent communication between the first and second layers of liquid crystal material. Electrical conductors interconnect the first row electrodes and the second row electrodes and electrical conductors interconnect the first column electrodes and the second column electrodes. Row driver electronics are electrically coupled to one of the first row electrodes and the second row electrodes for applying voltage to both the first row electrodes and the second row electrodes. Column driver electronics are electrically coupled to one of the first column electrodes and the second column electrodes for applying voltage to both the first column electrodes and the second column electrodes. This disclosure also suffers from having multiple supports in the line of sight through the device.

WO2005/081779 relates generally to driving a layered liquid crystal display. More specifically, this application relates to a color display utilizing layered bistable liquid crystals with shared electrode addressing. A stacked color liquid crystal display uses shared electrode addressing including a plurality of liquid crystal layers each sandwiched between electrically conductive layers. Adjacent liquid crystal layers share one or two electrode layers located between the adjacent liquid crystal layers: A driving scheme is provided that allows the display to be driven by updating the liquid crystal layers sequentially, concurrently, or some combination of the two. Further, a method of manufacturing the display using a deposition process is also disclosed. This display requires a plurality of alternating transparent electrodes (i.e. patterned alternating rows and columns) between stacks of liquid crystal layers. Although this is desirable when addressing full color displays the requirement of alternating electrodes adds to the number of independent driver signals required, the number of connections required and increases the complexity of fabrication all leading to higher system costs. These displays also lack the interposed absorbing layer between the electrodes thus reducing the effectiveness of the contrasting absorber layer.

### PROBLEM TO BE SOLVED

It is highly desirable to lower the drive voltage required to reset a passive matrix polymer dispersed cholesteric liquid crystal display having only one transparent substrate, without substantially reducing the total brightness and contrast of the device.

### SUMMARY OF THE INVENTION

The present invention relates to a display comprising, in order, a support, a first patterned conductor, a first level of electrically modulated imaging material, a coextensive common electrode conductor, a second level of electrically modulated imaging material, and a second patterned conductor. The present invention also includes a method of imaging a display element comprising providing a display element comprising, in order, a support, a first patterned conductor, a first level of electrically modulated imaging material, a coextensive common electrode conductor, a second level of electrically modulated imaging material, and a second patterned conductor, identifying an area to be updated of the display element, wherein the area to be updated comprises rows of pixels, wherein the pixels are formed by the first patterned conductor and second patterned conductor, applying a sequence of drive signals having a 3-phase approach to image said display element, wherein the 3-phase approach comprises in phase 1, applying a first pixel voltage across the pixels of the area to be updated such that the critical voltage is reached; and holding the first pixel voltage until a homeotropic texture is reached, in phase 2, setting a second pixel voltage to allow the homeotropic texture to relax into a stable planar texture, wherein the second pixel voltage is a substantially low voltage, in phase 3, the coextensive common electrode is allowed to float, while selecting one row of pixels of the rows of pixels, formed by the first patterned electrode and second patterned electrode, and updating the one row of pixels by sequential addressing, wherein sequential addressing comprises applying a third pixel voltage, capable of switching the pixels from the stable planar texture to the non-reflective focal conic texture, across the pixels to produce switched pixels, applying a fourth pixel voltage, incapable of switching the pixels from the stable planar texture to the non-reflective focal conic texture, to produce unswitched pixels to remain in the stable planar texture, and repeating the addressing until all rows of pixels of the area to be updated have been addressed.

### ADVANTAGEOUS EFFECT OF THE INVENTION

The present invention includes several advantages, not all of which are incorporated in a single embodiment. The present invention, through the use of a common electrode located between liquid crystal layers, which are, in turn, located between patterned electrodes, cuts the erase voltage requirement in half, without substantially reducing the total brightness and contrast of the device, as occurs if one simply reduces the thickness of liquid crystal or absorber layer interposed between the addressable row and column electrodes. The current invention achieves these goals with a minimum of added complexity thus maintaining display brightness and contrast while greatly reducing system cost.

### BRIEF DESCRIPTION OF THE DRAWINGS

The invention as described herein can be understood with reference to the accompanying drawings as described below:

FIGS. 1a and 1b are isometric views of a traditional, voltage driven display structure;

FIGS. 2a and 2b are isometric views of a voltage driven display structure utilizing a common electrode layer;

FIG. 3 is a side view of a traditional, voltage driven display structure;

FIG. 4 is a side view of a voltage driven display structure utilizing a common electrode layer;

FIGS. 5a, 5b and 5c are side views illustrating a first drive sequence to write a display using a common electrode;

FIGS. 6a, 6b and 6c are side views illustrating a second drive sequence to write a display using a common electrode;

FIG. 7 is graph illustrating the stabilized reflectance vs. voltage of a display element given planar of focal conic initial conditions.

FIG. 8 illustrates one embodiment of a common electrode structure.

FIG. 9 illustrates the use of the common electrode structure of FIG. 8 to produce a display with a red top portion.

FIG. 10 illustrates the use of the common electrode structure of FIG. 8 to produce a display with a blue side portion.

FIG. 11 the use of the common electrode structure of FIG. 8 to produce a display with combined colored areas or spots, with red top and bottom portions and blue side portions.

The drawings are exemplary only, and depict various embodiments of the invention. Other embodiments will be apparent to those skilled in the art upon review of the accompanying text.

### DETAILED DESCRIPTION OF THE INVENTION

The present invention relates to a support, a first conductor patterned into columns, a first layer of electrically modulated imaging material, a common electrode coextensive across multiple columns, a second layer of electrically modulated imaging material, and a second electrode patterned into rows. The invention includes an element and a method for making the element. The device may include a color contrast or pigmented layer and a field spreading layer or layers may be incorporated on either side of the electrically modulated imaging material—common electrode—electrically modulated imaging material stack, adjacent to the first and second electrodes, as well as other functional layers or may be incorporated in a contrasting absorber layer. Specific means of energizing the electrodes to reset and select image data are also included. A preferred embodiment of the present invention integrates two stacked displays in the most efficient way. Particular uses are intended in flexible chiral nematic liquid crystal displays, as well as other field driven displays, such as electrophorectic displays. The invention also reduces the number of drive channels needed, compared with alternative methods, thus reducing system cost and, in some embodiments, can provide spot color.

The structure of a bistable, voltage driven display can be modified to significantly reduce the required drive voltage by adding an additional electrode to the center of the display material layer. This has been specifically demonstrated in the case when cholesteric liquid crystal (ChLC) is the display material used. Cholesteric liquid crystal can be made such that it has two stable optical conditions, hereafter referred to as “focal conic” and “planar”. The focal conic state refers to a condition when the liquid crystal material is predominantly transparent. Planar refers to a second optical state, in which the material is reflective, typically to a specific band of optical wavelengths. Depending on the helical twist of the liquid crystal, the wavelength reflected can be a narrow band, such as a single color, or broadband, reflecting a wider spectrum of colors.

In certain cholesteric liquid crystal drive configurations, higher voltages can be required to obtain the planar state. One specific example of this is a drive method referred to as “left hand slope” (LHS). In the left hand slope scheme, the entire display is driven to the planar state, using a relatively high voltage, for example 150V. Then selected areas are driven to the focal conic state, which typically requires a lower voltage, for example 20V. Most voltage driven systems are essentially acting as capacitors, which means if the thickness of the material is reduced, then the voltage required to drive them is also reduced. For example, if the thickness of the display material were to be cut in half, then the drive voltage would also be cut in half. The unfortunate side effect of this is that the reflectance of the display material planar state also tends to be reduced by a similar ratio. Hence it is desirable to have a system that can reduce the drive voltage of the display, without reducing the effective thickness of the display material.

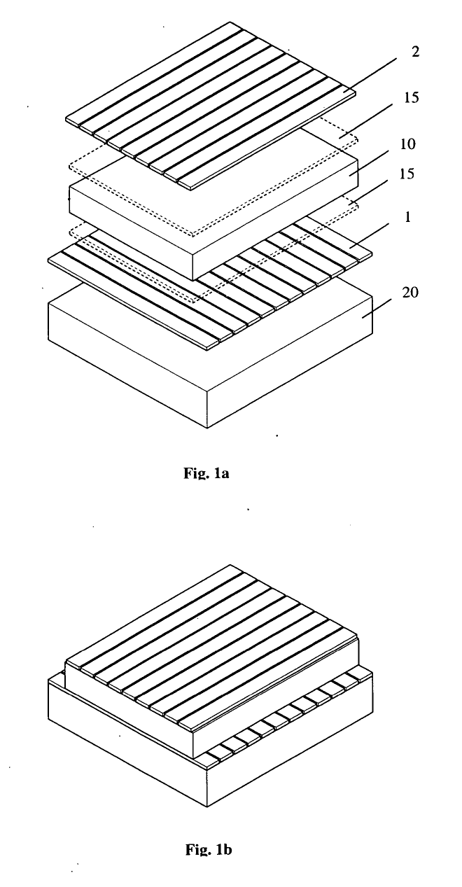

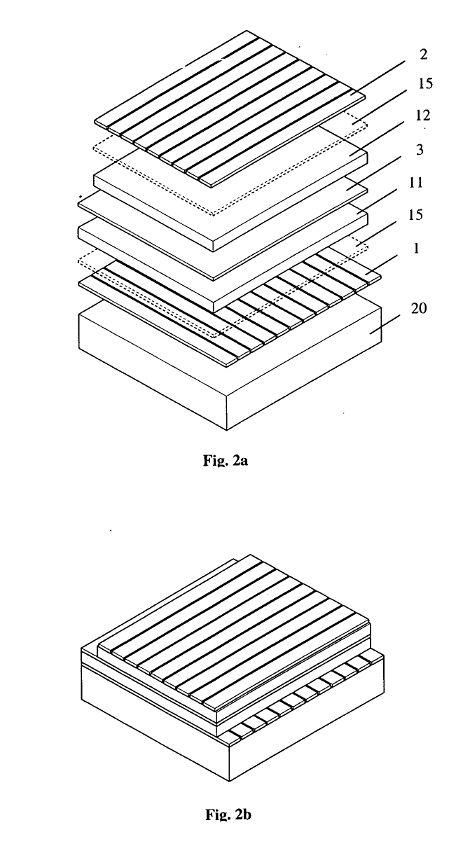

FIG. 1a and b show a traditional voltage based display, which utilizes a substrate 20, a first conductor 1, a full layer of display imaging material 10, and a second conductor 2. The system can also include an optional colored layer, hereafter referred to as a nano layer 15. This layer can be located anywhere in the display stack, depending on the transparency of the other layers. The primary purpose is to increase the contrast between the focal conic and planar states by absorbing additional wavelengths of light, making the focal conic state appear darker. For this reason, the nano layer is typically located on the side of the display imaging layer distal from the viewer.

The traditional display is written using the left hand slope method by first writing the entire display to the planar state, then writing individual pixels to the focal conic state. In a passive matrix system, this is accomplished by applying a first voltage to all of the electrodes in the first conductor and a second voltage to all of the electrodes in the second conductor. This writes the display to planar. Selected pixels are then written by applying writing voltages to selected electrodes in the first and second conductor, and non-write (or “hold”) voltages to the unselected areas. A full write of the display can require several “scans”, or sequences of sending several combinations of write and non-write signals to various electrodes.

FIG. 2a and b show an improved system, which adds a third electrode to the system to reduce drive voltage with no significant penalty in reflectance. This new structure utilizes a substrate 20, a first conductor 1, a first layer of electrically modulated imaging material, also referred to herein as display imaging material, 11, a common electrode 3, a second layer of electrically modulated imaging material, also referred to herein as display imaging material, 12, and a second conductor 2. As in the traditional display, an optional nano layer 15 can also be included.

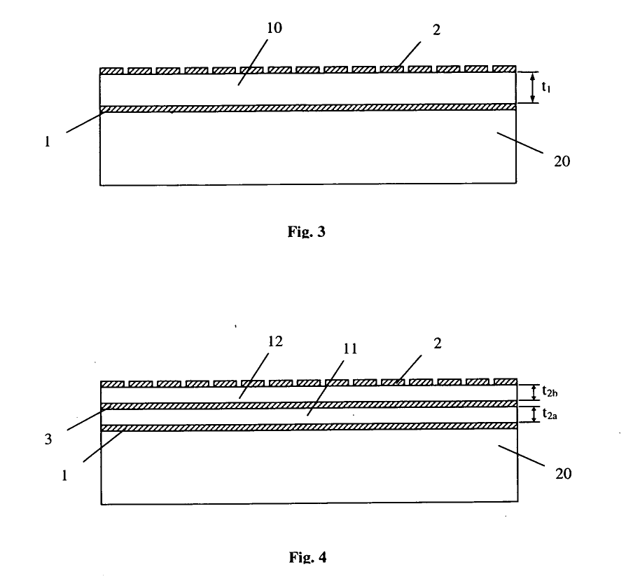

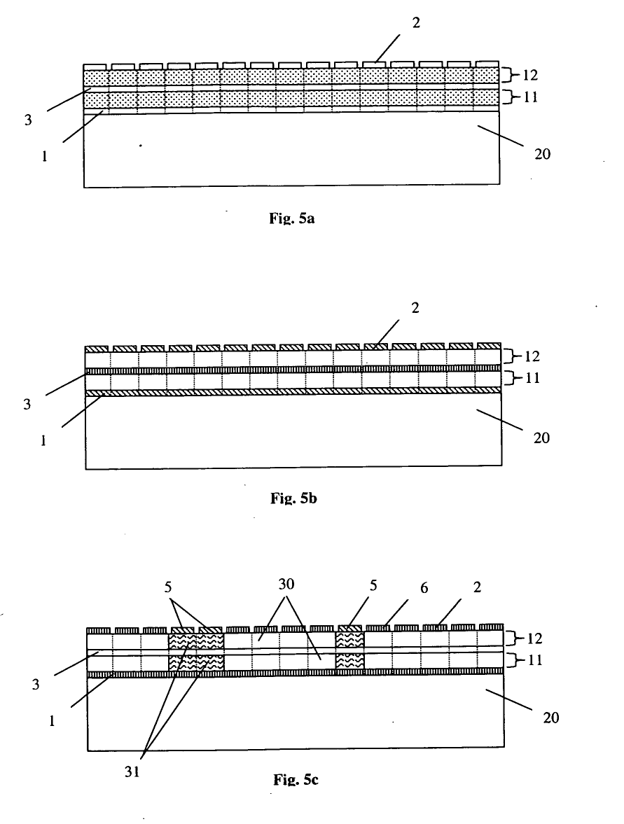

The purpose of the common electrode is to reduce the drive voltage without effecting total display brightness, or greatly increasing the number of drive channels required. FIGS. 3 and 4 show side views of the traditional and common electrode systems respectively. The thickness of the full display imaging layer 10 is designated by t₁ and the thickness of the first and second display imaging layers are designated by t₂ₐ and t_{2b} respectively. In one embodiment, t₂ₐ can be equal to t_{2b}, and the sum of t₂ₐ and t_{2b} can be equal to t₁, resulting in an equivalent total reflectance of the system if the same imaging material is used. In this situation, if the common electrode 3 was allowed to “float” electrically, then the two systems could be driven identically.

However, FIGS. 5a, 5b, and 5c show an alternative drive method, which can significantly reduce the drive voltage required, without paying a penalty in optical performance. FIG. 5a shows the initial condition of the material. In this example, all electrically modulated imaging material, also referred to herein as display materials, are shown in a mixed planar/focal conic state (as can be the case upon manufacture), and the electrodes are uncharged. This is only an example, and not the required initial state. The material can be in any optical state and still be driven using this method. FIG. 5b shows the planar reset, in which a first write voltage is applied to the common electrode 3, and a second write voltage is applied to all electrodes of the first and second conductors 1,2 sufficient to write all pixels to the planar state. As the effective thickness of the system is now only one half of t₁, the voltage required to achieve planar state is also reduced. FIG. 5c shows the write portion of the sequence, in which the selected pixels to be written to focal conic state are addressed. This is accomplished by applying the appropriate write voltages to the selected electrodes 5 of the first and second conductors, while the unselected electrodes 6 are set to a hold voltage, and the common electrode 3 is allowed to electrically float. Note that the voltage required to write full thickness display material to the focal conic state is typically lower than that to write even half thickness material to the planar state. Using this method, one or more scans of the display can create a pattern of focal conic pixels 31 and unchanged planar pixels 30 to form a desired image, where the overall voltage required to write the display is half that required to write a comparable traditional display.

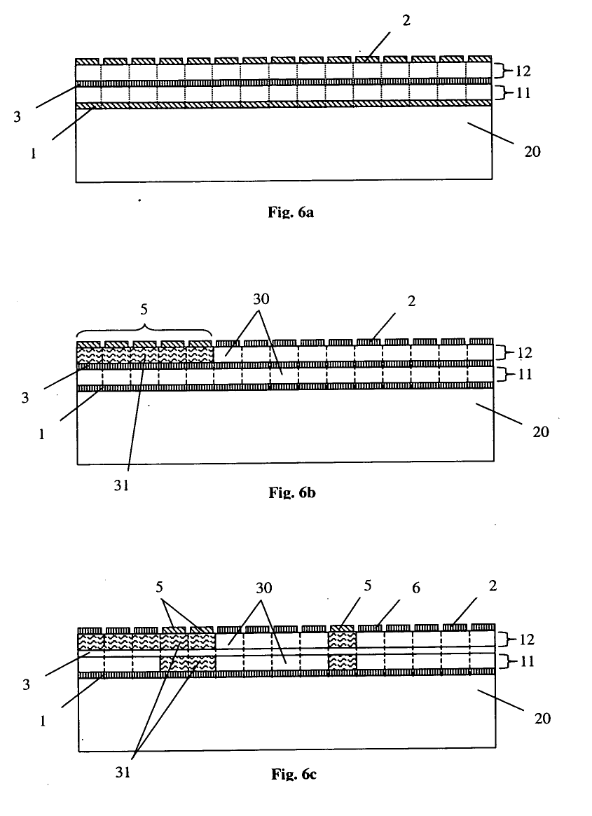

FIGS. 6a, 6b, and 6c show an alternative drive and structure that allow the additional capability of having adjustable spot color on an initially monochrome, such as black and white, display, by using a common electrode. In this configuration, the first and second imaging layer 11, 12 can be made to reflect different wavelengths of light. If these wavelengths are complimentary, for example cyan and red, and a black nano layer is used, then when both are set to the planar state, the display will appear white. If the display is written in the same manner as was described in FIG. 5, then the final image will appear to be black and white. However, if the layers are individually addressed, then areas of the individual other colors can be shown as well. FIG. 6a again shows the common electrode planar reset, as was described earlier. Areas of spot color can then be added by writing one or more area of either the first imaging layer 11 or second imaging layer 12 to the focal conic state, leaving the planar pixels 30 of that area to be the color of the non-written layer. An example of this is shown in FIG. 6b. In this embodiment, a write voltage is applied to one or more sets of electrodes on the second conductive layer 2, while a second write voltage is applied to all the remaining electrodes. This includes all remaining electrodes on the second conductive layer 2, all electrodes the first conductive layer 1, and the common electrode 3. This will set the portions of the second imaging layer 12 between the selected electrodes 5 and the unselected electrodes 6 to become focal conic pixels 31, while the remaining display material remains as planar pixels 30. FIG. 6c shows the individual focal conic pixels 31 being written as described in earlier embodiments. In this embodiment, if the second imaging layer 12 is cyan, the first imaging layer 11 is red, and the nano layer is black, then the display can consist of pixels that are either black (both layers focal conic), red (second imaging layer focal conic), cyan (first imaging layer focal conic), or white (both layers planar).

The device of the present invention includes a support. The support may be any self-supporting material. The most preferred support is a flexible support, especially a plastic support. The flexible plastic substrate can be any flexible self-supporting plastic film that supports the thin conductive metallic film. “Plastic” means a high polymer, usually made from polymeric synthetic resins, which may be combined with other ingredients, such as curatives, fillers, reinforcing agents, colorants, and plasticizers. Plastic includes thermoplastic materials and thermosetting materials.

The flexible plastic film must have sufficient thickness and mechanical integrity so as to be self supporting, yet should not be so thick as to be rigid. Typically, the flexible plastic substrate is the thickest layer of the composite film in thickness. Consequently, the substrate determines to a large extent the mechanical and thermal stability of the fully structured composite film.

Another significant characteristic of the flexible plastic substrate material is its glass transition temperature (Tg). Tg is defined as the glass transition temperature at which plastic material will change from the glassy state to the rubbery state. It may comprise a range before the material may actually flow. Suitable materials for the flexible plastic substrate include thermoplastics of a relatively low glass transition temperature, for example up to 150° C., as well as materials of a higher glass transition temperature, for example, above 150° C. The choice of material for the flexible plastic substrate would depend on factors such as manufacturing process conditions, such as deposition temperature, and annealing temperature, as well as post-manufacturing conditions such as in a process line of a displays manufacturer. Certain of the plastic substrates discussed below can withstand higher processing temperatures of up to at least about 200° C., some up to 300-350° C., without damage.

Typically, the flexible plastic substrate is polyethylene terephthalate (PET), polyethylene naphthalate (PEN), polyethersulfone (PES), polycarbonate (PC), polysulfone, a phenolic resin, an epoxy resin, polyester, polyimide, polyetherester, polyetheramide, cellulose acetate, aliphatic polyurethanes, polyacrylonitrile, polytetrafluoroethylenes, polyvinylidene fluorides, poly(methyl (x-methacrylates), an aliphatic or cyclic polyolefin, polyarylate (PAR), polyetherimide (PEI), polyethersulphone (PES), polyimide (PI), Teflon poly(perfluoro-alboxy) fluoropolymer (PFA), poly(ether ether ketone) (PEEK), poly(ether ketone) (PEK), poly(ethylene tetrafluoroethylene)fluoropolymer (PETFE), and poly(methyl methacrylate) and various acrylate/methacrylate copolymers (PMMA). Aliphatic polyolefins may include high density polyethylene (HDPE), low density polyethylene (LDPE), and polypropylene, including oriented polypropylene (OPP). Cyclic polyolefins may include poly(bis(cyclopentadiene)). A preferred flexible plastic substrate is a cyclic polyolefin or a polyester. Various cyclic polyolefins are suitable for the flexible plastic substrate. Examples include Arton® made by Japan Synthetic Rubber Co., Tokyo, Japan; Zeanor T made by Zeon Chemicals L.P., Tokyo Japan; and Topas® made by Celanese A. G., Kronberg Germany. Arton is a poly(bis(cyclopentadiene)) condensate that is a film of a polymer. Alternatively, the flexible plastic substrate can be a polyester. A preferred polyester is an aromatic polyester such as Arylite. Although various examples of plastic substrates are set forth above, it should be appreciated that the substrate can also be formed from other materials such as glass and quartz.

The flexible plastic substrate can be reinforced with a hard coating. Typically, the hard coating is an acrylic coating. Such a hard coating typically has a thickness of from 1 to 15 microns, preferably from 2 to 4 microns and can be provided by free radical polymerization, initiated either thermally or by ultraviolet radiation, of an appropriate polymerizable material. Depending on the substrate, different hard coatings can be used. When the substrate is polyester or Arton, a particularly preferred hard coating is the coating known as “Lintec”. Lintec contains UV cured polyester acrylate and colloidal silica. When deposited on Arton, it has a surface composition of 35 atom % C, 45 atom % O, and 20 atom % Si, excluding hydrogen. Another particularly preferred hard coating is the acrylic coating sold under the trademark “Terrapin” by Tekra Corporation, New Berlin, Wis.

At least one two conductive layers are present in display devices. A first conductor is formed over substrate. The first conductor can be a transparent, electrically conductive layer of tin oxide or indium tin oxide (ITO), with ITO being the preferred material. Alternatively, first conductor can be an opaque electrical conductor formed of metal such as copper, aluminum or nickel. If first conductor is an opaque metal, the metal can be a metal oxide to create a light absorbing first conductor. This conductive layer may comprise other metal oxides such as indium oxide, titanium dioxide, cadmium oxide, gallium indium oxide, niobium pentoxide and tin dioxide. See, Int. Publ. No. WO 99/36261 by Polaroid Corporation. In addition to the primary oxide such as ITO, the at least one conductive layer can also comprise a secondary metal oxide such as an oxide of cerium, titanium, zirconium, hafnium and/or tantalum. See, U.S. Pat. No. 5,667,853 to Fukuyoshi et al. (Toppan Printing Co.) Other transparent conductive oxides include, but are not limited to ZnO₂, Zn₂SnO₄, Cd₂SnO₄, Zn₂In₂O₅, MgIn₂O₄, Ga₂O₃—In₂O₃, or TaO₃.

The conductive layer may be formed, for example, by a low temperature sputtering technique or by a direct current sputtering technique, such as DC sputtering or RF-DC sputtering, depending upon the material or materials of the underlying layer. Typically, the conductive layer is sputtered onto the substrate to a resistance of less than 250 ohms per square.

A second conductor may be applied to the surface of light modulating imaging layer. The second conductor should have sufficient conductivity to carry a field across light modulating imaging layer. The second conductive layer may comprise any of the electrically conductive materials discussed for use in the first transparent conductive layer. However, the second conductive layer need not be transparent. The second conductive layer may be formed in a vacuum environment using materials such as aluminum, tin, silver, platinum, carbon, tungsten, molybdenum, or indium. Oxides of these metals can be used to darken patternable conductive layers. The metal material can be excited by energy from resistance heating, cathodic arc, electron beam, sputtering or magnetron excitation. The second conductive layer may comprise coatings of tin oxide or indium tin oxide, resulting in the layer being transparent. Alternatively, second conductive layer may be printed conductive ink. For higher conductivities, the conductive layer may comprise a silver-based layer which contains silver only or silver containing a different element such as aluminum (Al), copper (Cu), nickel (Ni), cadmium (Cd), gold (Au), zinc (Zn), magnesium (Mg), tin (Sn), indium (In), tantalum (Ta), titanium (Ti), zirconium (Zr), cerium (Ce), silicon (Si), lead (Pb) or palladium (Pd). The electrodes are electrically isolated from each other. The present invention contains an electrically modulated imaging layer which is a field or voltage driven switching layer. No layer may be located between the conductive elements of the present invention which would significantly reduce the ability of these conductive layers to produce a field capable of switching the electrically modulated imaging layer or layers therebetween.

In addition to a second conductive layer, other means may be used to produce a field capable of switching the state of the liquid crystal layer as described in, for example, U.S. Pat Appl. Nos. 20010008582 A1, 20030227441 A1, 20010006389 A1, and U.S. Pat. Nos. 6,424,387, 6,269,225, and 6,104,448, all incorporated herein by reference.

The transparent common electrode is coextensive with multiple row and column electrode. It is common in the sense that multiple independently addressable pixels share the coextensive electrode. Contact to the common electrode can be made, for example, at a single point at an outer edge of the display area and the resulting electrical signal on the common electrode is shared between multiple rows and columns in the device. The common electrode material, or combinations of materials, can be selected from any of the same substances used for the transparent electrode as previously enumerated but may be considerably thinner, and therefore more transparent, because its effective area is much larger than the row or column electrodes.

The display includes a suitable electrically modulated imaging material disposed on a suitable support structure, such as on or between one or more electrodes. The electrically modulated, imageable material can be light emitting or light modulating. Light emitting materials can be inorganic or organic in nature. Particularly preferred are organic light emitting diodes (OLED) or polymeric light emitting diodes (PLED). The light modulated imaging material can be reflective or transmissive. The electrically modulated imageable material can be addressed with an electric field and then retain its image after the electric field is removed, a property typically referred to as “bistable”. The electrically modulated imaging material may be electrochromic material, electrochemical, electrophoretic, such as Gyricon particles, rotatable microencapsulated microspheres, liquid crystal materials, cholesteric/chiral nematic liquid crystal materials, polymer dispersed liquid crystals (PDLC), polymer stabilized liquid crystals, surface stabilized liquid crystals, smectic liquid crystals, ferroelectric material, electroluminescent material or any other of a very large number of light modulating imaging materials known in the prior art. The liquid crystalline material can be twisted nematic (TN), super-twisted nematic (STN), ferroelectric, magnetic, or chiral nematic liquid crystals. Especially preferred are chiral nematic liquid crystals. The chiral nematic liquid crystals can be polymer dispersed liquid crystals (PDLC). Structures having stacked imaging layers or multiple support layers, however, are optional for providing additional advantages in some case.

The liquid crystal (LC) is used as an optical switch. The supports are usually manufactured with transparent, conductive electrodes, in which electrical “driving” signals are coupled. The driving signals induce an electric field which can cause a phase change or state change in the liquid crystal material, the liquid crystal exhibiting different light reflecting characteristics according to its phase and/or state.

Liquid crystals may be nematic (N), chiral nematic (N*), or smectic, depending upon the arrangement of the molecules in the mesophase. In the preferred embodiment, the electrically modulated imaging material is a chiral nematic liquid crystal incorporated in a polymer matrix. Chiral nematic liquid crystalline materials may be used to create electronic displays that are both bistable and viewable under ambient lighting. Furthermore, the liquid crystalline materials may be dispersed as micron sized droplets in an aqueous medium, mixed with a suitable binder material and coated on a flexible conductive support to create potentially low cost displays. The operation of these displays is dependent on the contrast between the planar reflecting state and the weakly scattering focal conic state.

Chiral nematic liquid crystal refers to the type of liquid crystal having finer pitch than that of twisted nematic and super-twisted nematic. Chiral nematic liquid crystals are so named because such liquid crystal formulations are commonly obtained by adding chiral agents to host nematic liquid crystals. Chiral nematic liquid crystals may be used to provide bistable and multistable reflective displays that, due to their non-volatile “memory” characteristic, do not require a continuous driving circuit to maintain a display image, thereby significantly reducing power consumption. Chiral nematic displays are bistable in the absence of a field, the two stable textures being the reflective planar texture and the weakly scattering focal conic texture. In the planar texture, the helical axes of the chiral nematic liquid crystal molecules are substantially parallel to the support upon which the liquid crystal is disposed. In the focal conic, state the helical axes of the liquid crystal molecules are generally randomly oriented. By adjusting the concentration of chiral dopants in the chiral nematic material, the pitch length of the molecules and, thus, the wavelength of radiation that they will reflect, may be adjusted. Chiral nematic materials that reflect infrared radiation have been used for purposes of scientific study. Commercial displays are most often fabricated from chiral nematic materials that reflect visible light. Some known LCD devices include chemically etched, transparent, conductive layers overlying a glass substrate as described in U.S. Pat. No. 5,667,853, incorporated herein by reference. The present invention may employ, as a light modulating layer, chiral nematic liquid crystal compositions dispersed in a continuous matrix. Such materials are referred to as “polymer dispersed liquid crystal” materials or “PDLC” materials.

Modem chiral nematic liquid crystal materials usually include at least one nematic host combined with a chiral dopant. Suitable chiral nematic liquid crystal compositions preferably have a positive dielectric anisotropy and include chiral material in an amount effective to form focal conic and twisted planar textures. Chiral nematic liquid crystal materials are preferred because of their excellent reflective characteristics, bistability and gray scale memory. The chiral nematic liquid crystal is typically a mixture of nematic liquid crystal and chiral material in an amount sufficient to produce the desired pitch length.

Chiral nematic liquid crystal materials and cells, as well as polymer stabilized chiral nematic liquid crystals and cells, are well known in the art and described in, for example, U.S. Pat. No. 5,695,682, U.S. application Ser. No. 07/969,093, Ser. No. 08/057,662, Yang et al., Appl. Phys. Lett. 60(25) pp 3102-04 (1992), Yang et al., J. Appl. Phys. 76(2) pp 1331 (1994), published International Patent Application No. PCT/US92/09367, and published International Patent Application No. PCT/US92/03504, all of which are incorporated herein by reference.

The liquid crystalline layer or layers may also contain other ingredients. For example, while color is introduced by the liquid crystal material itself, pleochroic dyes may be added to intensify or vary the color reflected by the cell. Similarly, additives such as fumed silica may be dissolved in the liquid crystal mixture to adjust the stability of the various chiral nematic textures. A dye in an amount ranging from about 0.25% to about 1.5% may also be used.

The LCD may also comprise functional layers, including a conductive layer between the curable layers and the support and any of the layers described above as curable layers. One type of functional layer may be a color contrast layer. Color contrast layers may be radiation reflective layers or radiation absorbing layers. In some cases, the rearmost substrate of each display may preferably be painted black. The color contrast layer may also be other colors. In another embodiment, the dark layer comprises milled nonconductive pigments. The materials are milled below 1 micron to form “nanopigments”. A layer containing pigments milled below 1 micron is also referred to as a nano layer. The color contrast layer can be a nano layer. In a preferred embodiment, the dark layer absorbs all wavelengths of light across the visible light spectrum, that is from 400 nanometers to 700 nanometers wavelength. The dark layer may also contain a set or multiple pigment dispersions. The functional layer may comprise a protective layer or a barrier layer. In another embodiment, the polymeric support may further comprise an antistatic layer to manage unwanted charge build up on the sheet or web during roll conveyance or sheet finishing. The functional layer may also comprise a dielectric material. A dielectric layer, for purposes of the present invention, is a layer that is not conductive or blocks the flow of electricity.

At a minimum, the display comprises, in order, a substrate, a first conductive layer, a first electrically modulated imaging layer, a common electrode, a second electrically modulated imaging layer, and a second conductive layer. In a preferred embodiment, the conductive layer is ITO and the imaging layers are liquid crystalline material. The two liquid crystal layers may be comprised of chiral nematic liquid crystals. These two layers may have the same or opposite handedness of circular polarization reflection in the planar state. The light modulating imaging layers may have the same peak reflection wavelength or may cover different regions of the light spectrum. They will typically, but not necessarily, be about the same thickness. In one preferred embodiment, a contrasting light absorber layer will be coextensive between a light modulation layer and the non-transparent electrode. In a more preferred embodiment the contrasting light absorber layer will also be a field spreading layer.

The display may also comprise two sheets of polarizing material with an electrically modulated imaging solution between the polarizing sheets. The sheets of polarizing material may be a substrate of glass or transparent plastic. In one embodiment, a transparent, multilayer flexible support is coated with a first conductive layer, which may be patterned, onto which is coated an electrically modulated imaging layer. A second conductive layer is applied and overcoated with a functional layer. Dielectric conductive row contacts are attached, including via holes that permit interconnection between the conductive layers and the dielectric conductive row contacts.

In a typical matrix addressable light modulating display device, numerous light modulator devices are formed on a single substrate and arranged in groups in a regular grid pattern. Activation may be by rows and columns, or in an active matrix with individual cathode and anode paths.

In addition to displays, the present invention may be utilized in other applications. For example, another possible application is polymer films with a chiral liquid crystalline phase for optical elements, such as chiral nematic broadband polarizers or chiral liquid crystalline retardation films. Among these are active and passive optical elements or color filters and liquid crystal displays, for example STN, TN, AMD-TN, temperature compensation, polymer free or polymer stabilized chiral nematic texture (PFCT, PSCT) displays. Possible display industry applications include ultralight, flexible, and inexpensive displays for notebook and desktop computers, instrument panels, video game machines, videophones, mobile phones, hand held PCs, PDAs, e-books, camcorders, satellite navigation systems, store and supermarket pricing systems, highway signs, informational displays, smart cards, toys, and other electronic devices. The present invention may also be used in the production of other products, for example, sensors, medical test films, solar cells, fuel cells, to name a few.

A preferred drive method for the invention involves applying a sequence of drive signals having a 4-phase approach to image a bistable matrix addressable display element, which may be characterized as a planar reset, left slope selection method. In the first phase, the area of the display to be updated is reset to a planar texture. Referring to FIG. 5, an AC pixel voltage is applied between the common electrode 3 and the rows 2 and columns 1 such that the critical voltage is reached if not exceeded. The duration of the AC pixel voltage is held for a period suitable to achieve the homeotropic texture. In phase 2, the pixel voltage of the display is set to substantially low voltage to allow the homeotropic domains of the liquid crystal material to relax to the stable planar texture. Phase 3 is the scanning phase, the common electrode is floated (i.e. connected to high impedance) while each row of the display to be updated is addressed, preferably sequentially addressed. When the row is addressed, it is said to be “selected,” while any other row is said to be non-selected. In the selected row, pixels that are to be switched from the stable planar texture to the non-reflective focal conic texture receive a pixel voltage pulse across them greater than V1 to produce the planar to focal conic (P-FC) transition. Pixels that are to remain in the stable planar texture receive a pulse or set of pulses such that there is negligible effect on the final texture of the pixel, which is stable planar. After the pixel voltage pulse or pulses have sufficiently caused the planar—focal conic transition to select pixels in the selected row, the next row to be addressed is selected. The selection process is repeated until all rows have been addressed. This drive method or scheme can be described as a common electrode planar reset, left slope selection method. Finally, all pixel voltages are removed from the updated area of the display.

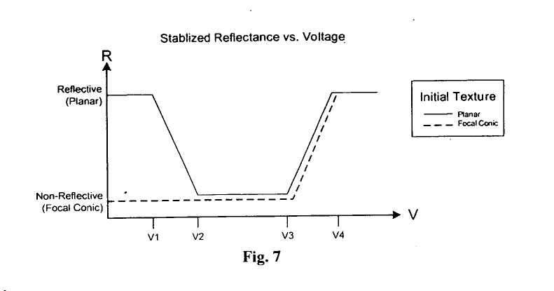

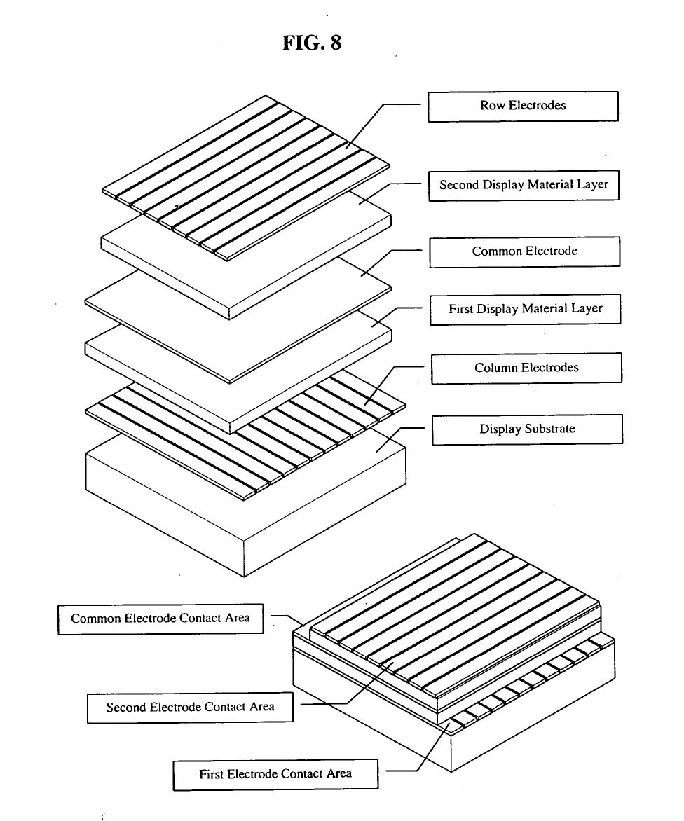

Specifically, FIG. 7 represents the stabilized reflectance of chiral nematic liquid crystal after the applied voltage has been removed and the chiral nematic liquid crystal is allowed to obtain a stable texture. This graph is typically obtained by first applying an AC pixel voltage for a fixed period of time to reset the display to a known texture, either focal conic or homeotropic. Following the reset period is a period where the display is allowed to stabilize into the initial texture. After the display has stabilized, an AC test voltage is applied to the chiral nematic liquid crystal for a fixed period of time and then removed. After a brief period of relaxation/stablization time, the reflectance of the chiral nematic liquid crystal is measured. A reset to the initial condition must be performed for every test voltage on the x-axis.

The drive method of this invention can have many variations. For example, the time to transition the pixels from stable planar to focal conic can be reduced by applying a selection voltage that is greater than V2 of FIG. 7. The voltage following this shortened high voltage pulse can be zero volts or it can be some holding voltage, as described in U.S. Patent application 2005/0024307 A1, incorporated herein by reference. There can be cases where there are multiple pulses. It is understood that in all cases where the display is first reset into the stable planar texture and then update by means of transitioning select pixels to the focal conic texture is the enabling feature of this invention.

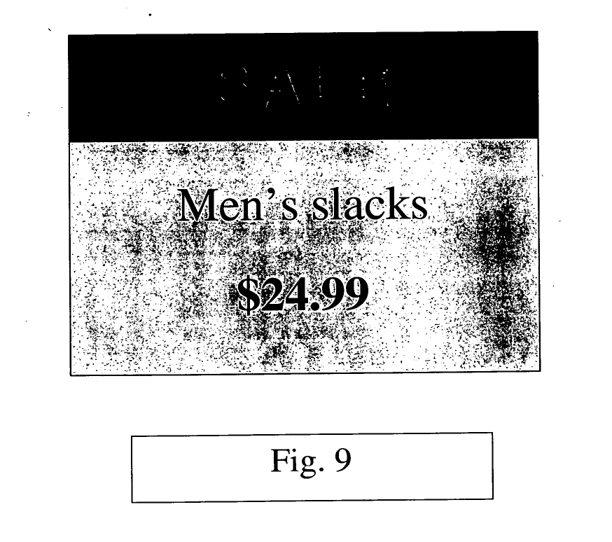

To produce a display with a red top portion as illustrated by FIG. 9, at least the following structure is required:

a. ITO Columns

b. Red LC

c. Common Electrode

d. Blue LC

e. Black Nano

f. Rows

The following steps would be performed using the structure:

Set both layers to planar texture.

Apply signal “x” to common electrode.

Apply signal “−x” to all rows and columns.

Write selected area to red, by setting selected rows of blue layer to focal conic texture.

Apply signal “x” to common electrode, all columns, and unselected rows.

Apply signal “−x” to selected rows.

Write selected pixels to black.

“Float” common electrode.

Apply signal “x” to row 1 and “−x” to desired columns and remaining rows.

Repeat for remaining rows.

Note: Drive signals “x” and “−x” refer to an AC drive signal and it's out of phase counterpart.

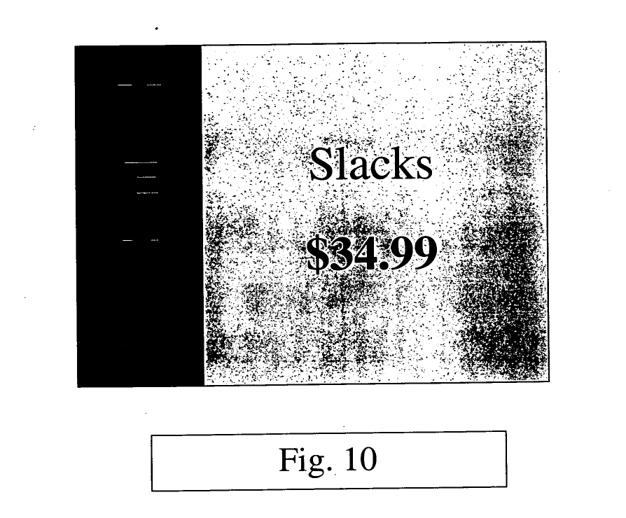

To produce a display with a blue side portion as illustrated by FIG. 10, at least the following structure is required:

a. ITO Columns

b. Red LC

c. Common Electrode

d. Blue LC

e. Black Nano

f. Rows

The following steps would be performed using the structure:

Set both layers to planar texture.

Apply signal “x” to common electrode.

Apply signal “−x” to all rows and columns.

Write selected area to blue, by setting selected columns of red layer to focal conic texture.

Apply signal “x” to common electrode, all rows, and unselected columns.

Apply signal “−x” to selected columns.

Write selected pixels to black.

“Float” common electrode.

Apply signal “x” to row 1 and “−x” to desired columns and remaining rows.

Repeat for remaining rows.

Note: Drive signals “x” and “−x” refer to an AC drive signal and it's out of phase counterpart.

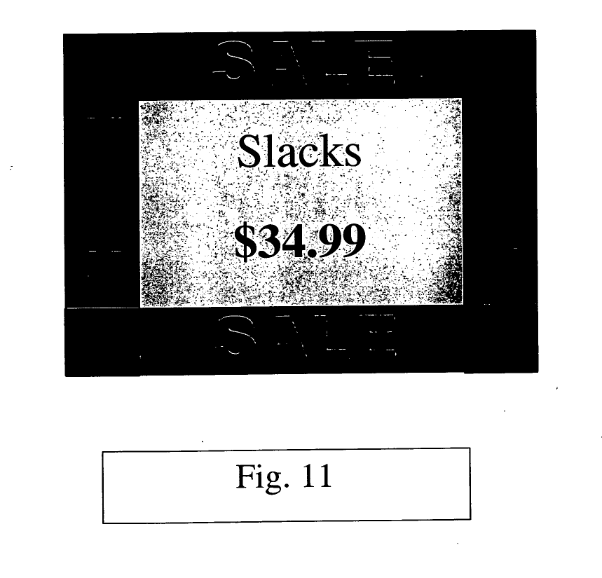

To produce a display with blue side portions and red top and bottom portions as illustrated by FIG. 11, at least the following structure is required:

a. ITO Columns

b. Red LC

c. Common Electrode

d. Blue LC

e. Black Nano

f. Rows

The following steps would be performed using the structure:

Set both layers to planar texture.

Apply signal “x” to common electrode.

Apply signal “−x” to all rows and columns.

Write selected areas blue and red, by setting areas of red and blue layers to focal conic texture.

Apply signal “x” to common electrode, unselected rows, and unselected columns.

Apply signal “−x” to selected columns and rows.

Write selected pixels to black.

“Float” common electrode.

Apply signal “x” to row 1 and “−x” to desired columns and remaining rows.

Repeat for remaining rows.

Note: Drive signals “x” and “−x” refer to an AC drive signal and it's out of phase counterpart.

The following examples are provided to illustrate the invention.

Control 1 (Two Imaging Layers without an Intervening Common Electrode)

A control can be prepared to compare the response of a display with and without a common electrode. The emulsion was prepared using cholesteric liquid crystal oil MERCK BL118, available from E.M. Industries of Hawthorne, N.Y. U.S.A. by limited coalescence in accordance with the procedure described in U.S. Pat. No. 6,556,262 to Stephenson.

For an emulsion having domain size of approximately 10 microns, the following procedure was used: The emulsions were made by first preparing BL118 slurry. A solution of 230 gms of distilled water, 103.5 gms BL118, 3.41 gms LUDOX® M50, and 7.12 gms of MAE adipate. Simultaneously, a solution of MAE adipate consisting of 2.0 gms MAE adipate and 18 gms distilled water. The solutions were added together, heated to 50C, and mixed with a high shear Silverson mixer at 5000 rpm for 2 minutes. The solution is then passed through a Microfluidizer twice at 3000 psi at 50C. 408 gms of a 1000 gm batch of gelatin solution, made of 90 gms of dry gel, 2 gms of biocide to 908 gins of water, melted at 50C, is then added to the Microfluidized BL118 slurry.

A 30 pixel per inch passive matrix display was prepared as follows. Five inch wide polyethylene terephthalate support, having ITO sputter coated to a resistance of 300 Ohms per square, obtained from Bekaert Specialty Films, San Diego Calif., was patterned across the web with a focused laser beam to produce electrically isolated columns separated by about 100 micron gaps. In addition to the laser etched lines to isolate the columns, lines were etched across the columns approximately 0.5 cm from the top edge of the support. This was done to allow edge contact with the subsequent ITO sputter-coated layer without shorting to the columns.

The bottom layer coating was prepared by making aqueous coating solutions, each containing 8 weight percent of the liquid crystal emulsion specified in and 5 weight percent gelatin and about 0.2 weight percent of a coating surfactant. The coating solution was heated to 45° C., to reduce the viscosity of the emulsion to approximately 8 centipoises. The polyethylene terephthalate substrate with 125-micron thickness and 5-inch width having an Indium Tin Oxide conductive layer (300 ohms/sq.) was continuously coated and dried with the heated emulsion at 46.1 cm³/m² on a coating machine.

Using the same coating solution as above, the sample had a second imaging layer knife coated to yield a wet thickness of 46.1 cm³/m². Once dried, the color contrast layer was prepared as follows. A 2% solution by weight of photographic gelatin and deionized water was mixed and heated to 45° C. Once the mixture was homogenized, a combination of magenta and cyan nonconductive pigments milled to less than 1 micron in size was added to the solution to formulate a blue color. This solution was knife coated to yield a wet thickness of 43.0 cm³/m².

After the coating was complete, the second conductor was applied using a screen-printed UV curable silver ink (Allied Inc.) patch to make displays of the invention.

### EXAMPLE 1

### Two Imaging Layers with an Intervening Common Electrode

An experiment was performed to examine the effects of adding a conductive layer to the top of the chiral nematic liquid crystal. The emulsion was prepared using cholesteric liquid crystal oil MERCK BL118, available from E.M. Industries of Hawthorne, N.Y. U.S.A. by limited coalescence in accordance with the procedure described in U.S. Pat. No. 6,556,262 to Stephenson.

For an emulsion having domain size of approximately 10 microns, the following procedure was used: The emulsions were made by first preparing BL118 slurry. A solution of 230 gms of distilled water, 103.5 gms BL118, 3.41 gms LUDOX® M50, and 7.12 gms of MAE adipate. Simultaneously, a solution of MAE adipate consisting of 2.0 gms MAE adipate and 18 gms distilled water. The solutions were added together, heated to 50C, and mixed with a high shear Silverson mixer at 5000 rpm for 2 minutes. The solution is then passed through a Microfluidizer twice at 3000 psi at 50C. 408 gms of a 1000 gm batch of gelatin solution, made of 90 gms of dry gel, 2 gms of biocide to 908 gms of water, melted at 50C, is then added to the Microfluidized BL118 slurry.

A 30 pixel per inch passive matrix display was prepared as follows. Five inch wide polyethylene terephthalate support, having ITO sputter coated to a resistance of 300 Ohms per square, obtained from Bekaert Specialty Films, San Diego Calif., was patterned across the web with a focused laser beam to produce electrically isolated columns separated by about 100 micron gaps. In addition to the laser etched lines to isolate the columns, lines were etched across the columns approximately 0.5 cm from the top edge of the support. This was done to allow edge contact with the subsequent ITO sputter-coated layer without shorting to the columns.

The bottom layer coating was prepared by making aqueous coating solutions, each containing 8 weight percent of the liquid crystal emulsion specified in and 5 weight percent gelatin and about 0.2 weight percent of a coating surfactant. The coating solutions were heated to 45° C., to reduce the viscosity of the emulsion to approximately 8 centipoises. The polyethylene terephthalate substrate with 125-micron thickness and 5-inch width having an Indium Tin Oxide conductive layer (300 ohms/sq.) was continuously coated and dried with the heated emulsion at 46.1 cm³/m² on a coating machine.

After the bottom layer is coated, dried and wound together, the roll was sputter-coated with ITO, forming a transparent conductive layer having a surface resistance of approximately 50-100 ohms/sq. The ITO layer was offset from the coating layer below to allow electrical contact along the top edge. The sputter coating was achieved by DC sputtered ITO from a 90%/10% Indium to Tin evaporative source.

Using the same coating solution as above, the sample was knife coated to yield a wet thickness of 46.1 cm³/m². Once dried, the color contrast layer was prepared as follows. A 2% solution by weight of photographic gelatin and deionized water was mixed and heated to 45° C. Once the mixture was homogenized, a combination of magenta and cyan nonconductive pigments milled to less than 1 micron in size was added to the solution to formulate a blue color. This solution was knife coated to yield a wet thickness of 43.0 cm³/m².

After the coating was complete, the second conductor was applied using a screen-printed UV curable silver ink (Allied Inc.) patch to make displays of the invention.

Control Drive Method

The drive method used to test the control and example involves a 3-phase approach. In the first phase, the area of the display to be updated is reset to a planar texture. An AC voltage is applied across the first and second conductor (rows and columns) such that the critical voltage is reached if not exceeded. The duration of the AC voltage (approximately 120 Volts) is held for a period suitable to achieve the homeotropic texture. In phase 2, the voltage of the display is set to substantially low voltage (approximately 0 Volts) to allow the homeotropic domains to relax to the stable planar texture. Phase 3 is the scanning phase, where each row of the display to be updated is sequentially addressed. When the row is addressed it is said to be “selected”, while any other row is said to be non-selected. In the selected row, pixels that are to be switched from the stable planar texture to the non-reflective focal conic texture receive a voltage pulse across them greater than V1 (approximately 40 Volts) to produce the planar-focal conic (P-FC) transition. Pixels that are to remain in the stable planar texture receive a pulse or set of pulses such that there is negligible effect on the final texture of the pixel, which is stable planar. After the voltage pulse or pulses have sufficiently caused the planar-focal conic transition to select pixels in the selected row, the next row to be addressed is selected. The selection process is repeated until all rows have been addressed.

The result of addressing the control and the example above yield acceptable images.

Experimental Drive Method

The drive method used with the experimental sample to illustrate the drive method of this invention involves the following approach. In the first phase, the area of the display to be updated is reset to a planar texture. An AC voltage is applied across the first and common electrode and the second and common electrode such that the critical voltage is reached if not exceeded. The duration of the AC voltage (approximately 60 Volts) is held for a period suitable to achieve the homeotropic texture. In phase 2, the voltage of the display is set to substantially low voltage (approximately 0 Volts) across the first and common electrode and the second and common electrode to allow the homeotropic domains to relax to the stable planar texture. Phase 3 is the scanning phase, where each row of the display to be updated is sequentially addressed. The common electrode is allowed to float, (i.e. attached to a high impedance). When the row is addressed it is said to be “selected”, while any other row is said to be non-selected. In the selected row, pixels that are to be switched from the stable planar texture to the non-reflective focal conic texture receive a voltage pulse across them greater than V1 (approximately 20 Volts) to produce the planar-focal conic (P-FC) transition. Pixels that are to remain in the stable planar texture receive a pulse or set of pulses such that there is negligible effect on the final texture of the pixel, which is stable planar. After the voltage pulse or pulses have sufficiently caused the planar-focal conic transition to select pixels in the selected row, the next row to be addressed is selected. The selection process is repeated until all rows have been addressed.

The experimental drive method yields acceptable images at ½ the reset voltage of the control drive method.

The invention has been described in detail with particular reference to certain preferred embodiments thereof, but it will be understood that variations and modifications can be effected within the spirit and scope of the invention.

1. A display comprising, in order, a support, a first patterned conductor, a first level of electrically modulated imaging material, a coextensive common electrode conductor, a second level of electrically modulated imaging material, and a second patterned conductor.

2. The display of claim 1 wherein said first patterned conductor is patterned into columns and said second patterned conductor is patterned into rows.

3. The display of claim 1 wherein said electrically modulated imaging material is a chiral nematic liquid crystal material.

4. The display of claim 1 wherein said electrically modulated imaging material is a polymer dispersed liquid crystal (PDLC) material.

5. The display of claim 1 wherein said first level of electrically modulated imaging material and said second level of electrically modulated imaging material comprise the same material.

6. The display of claim 1 wherein said first level of electrically modulated imaging material and said second level of electrically modulated imaging material comprise different materials.

7. The display of claim 6 wherein said first level of electrically modulated imaging material and said second level of electrically modulated imaging material comprise chiral materials having different twists.

8. The display of claim 6 wherein said first level of electrically modulated imaging material and said second level of electrically modulated imaging material comprise materials having different colors.

9. The display of claim 1 wherein said electrically modulated imaging material is an electrophorectic material.

10. The display of claim 1 wherein said coextensive common electrode conductor is unpatterned.

11. The display of claim 1 wherein said coextensive common electrode conductor is transparent.

12. The display of claim 1 wherein said coextensive common electrode conductor is colored.

13. The display of claim 1 wherein said coextensive common electrode conductor contains polythiophene.

14. The display of claim 1 wherein said coextensive common electrode conductor contains indium tin oxide.

15. The display of claim 1 further comprising a color contrast or pigmented layer.

16. The display of claim 1 further comprising field spreading layers on either side of said first and second patterned conductive layers opposite the electrically modulated imaging layers.

17. The display of claim 1 wherein said display is energized to reset and select image data via a sequence of drive signals having a 3-phase approach characterized as a planar reset, left slope selection method.

18. A method of imaging a display element comprising:
providing a display element comprising, in order, a support, a first patterned conductor, a first level of electrically modulated imaging material, a coextensive common electrode conductor, a second level of electrically modulated imaging material, and a second patterned conductor;
identifying an area to be updated of said display element, wherein said area to be updated comprises rows of pixels, wherein said pixels are formed by said first patterned conductor and said second patterned conductor;
applying a sequence of drive signals having a 3-phase approach to image said display element, wherein said 3-phase approach comprises:
in phase 1, applying a first pixel voltage across said pixels of said area to be updated such that the critical voltage is reached; and holding said first pixel voltage until a homeotropic texture is reached;
in phase 2, setting a second pixel voltage to allow said homeotropic texture to relax into a stable planar texture, wherein said second pixel voltage is a substantially low voltage;
in phase 3, said coextensive common electrode is allowed to float, while selecting one row of pixels of said rows of pixels, formed by said first patterned electrode and said second patterned electrode, of said area to be updated; and updating said one row of pixels by sequential addressing, wherein sequential addressing comprises:
applying a third pixel voltage, capable of switching said pixels from said stable planar texture to said non-reflective focal conic texture, across said pixels to produce switched pixels;
applying a fourth pixel voltage, incapable of switching said pixels from said stable planar texture to said non-reflective focal conic texture, to produce unswitched pixels to remain in the stable planar texture; and
repeating said addressing until said rows of pixels of said area to be updated have been addressed.

19. The method of claim 18 wherein said first pixel voltage, said second pixel voltage, said third pixel voltage, and said fourth pixel voltage comprise AC voltages.

20. The method of claim 18 wherein at least one of said first pixel voltage, said second pixel voltage, said third pixel voltage, and said fourth pixel voltage is a voltage pulse.

21. The method of claim 18 wherein said bistable chiral nematic liquid crystal imaging layer comprises a polymer dispersed bistable chiral nematic liquid crystal imaging layer.

22. The method of claim 18 wherein said first pixel voltage is an AC voltage of 60 Volts.

23. The method of claim 18 wherein said substantially low voltage is an AC voltage of approximately 0 Volts.

24. The method of claim 18 wherein said third pixel voltage is an AC voltage of 20 Volts.
